(19) United States
(12) Patent Application Publication
(10) Pub. No.: US 2003/0036946 A1
(43) Pub. Date: Feb. 20, 2003

(54) Capacity and material target forecasting system and method

(76) Inventors: Li-Kuei Lin, Taipei (TW); Yi-Ming Liao, Taipei (TW); Kuo-Ching Hong, Taipei (TW); Cheng-Ju Chen, Taipei (TW); Jen-Fu Lee, Taipei (TW); Dei-Chin Lee, Taipei (TW)

Correspondence Address: BIRCH STEWART KOLASCH & BIRCH, PO BOX 747, FALLS CHURCH, VA, 22040-0747, US

(21) Appl. No.: 09/931,936

(22) Filed: Aug. 20, 2001

(51) Int. Cl. G06F 17/60

(52) U.S. Cl. 705/10

(57) ABSTRACT

A system and a method with capacity and material target forecast, applied in the SCM (Supply Chain Management) of manufacturing industry to satisfy the requirements of E-fulfillment processes and CTP (Capable To Promise) multi-site production, to solve the problems of multi-site production, actual shipping and product sales, to decrease the stocking, and to ensuring correct material supply.

### BACKGROUND OF THE INVENTION

1. Field of Invention

The invention pertains to a system and a method with capacity and material target forecast. In particular, it relates to a system and a method with capacity and material target forecast for SCM (Supply Chain Management) in the manufacturing industry.

2. Related Art

Supply chain management software is a solution to the stocking problem in enterprises. Its services and supports in distribution management are exactly the logistics support management for the enterprise, which includes management of material supply, production planning and control, transportation, and actual shipping and sales. It controls the actual shipping and sales, stocking, and production processes via planning and controlling material flows, and fully utilizes system resources to achieve the specified service standards. According to statistics by the U.S. Council of Logistics Management, 20% to 30% of sales incomes in different industries covers the logistics costs. Therefore, the quality of logistics management certainly has a close relation with and a great influence on the cost and service quality of the whole production and sales system.

Along with the continuous development and improvement in information technology and business sizes, the services of an enterprise become more complicated and versatile. The traditional distribution management cannot fulfill the requirement of modern enterprises. Therefore, SCM (Supply Chain Management) with integrated and global views is thus created. Furthermore, the actual shipping process is particularly important since it involves the material purchase, storage, actual shipping and production that are mostly concerned by manufacturers.

Within the professional field of actual shipping, SCM further includes SCE (Supply Chain Execution), which is the technique that integrates the upstream and downstream of a supply chain and emphasizes on the execution of actual shipping processes. Recently, due to the rapid development in E-commerce related technologies, SCE further develops a more detailed technique called the E-fulfillment processes.

E-fulfillment processes are distinguished from usual MRP (Material Resource Planning) software. It is not only able to solve the problems of material and stocks management but can also extend the whole SCM to the other end of the suppliers, simultaneously solving the problems of materials and capacity. In particular, the trend that CTP (Capable To Promise) has moved from single-site to multi-site production, actual shipping and sales is the issue that should draw a lot of attentions for international businesses.

Current B2B E-commerce development focuses on how to conduct business on a network. However, the problems for the manufacturing industry are which material should be purchased, how to plan production processes after material being purchased, how to arrange material shipping after products come out, and how to manage extra stocks. For example, the estimate of capacity is not equivalent to formal orders from clients. Even formal orders may be changed or cancelled. Thus, there are often embarrassment and loss due to wrong orders and incorrect material preparation that result in insufficient materials or overstocking.

Consequently, a system and a method with capacity and material target forecast that satisfy the requirements in E-fulfillment processes and CTP multi-site production in the SCM has become an important issue in the manufacturing industry.

### SUMMARY OF THE INVENTION

The invention discloses a system and a method with capacity and material target forecast used in the SCM of the manufacturing industry. Its main goal is to combine the material storage, transportation and actual shipping with the production processes so as to effectively increase the efficiency while minimizing the stocks. Such a method can be coded into software through which a target forecast for the capacity and material becomes possible, ensuring that the materials are always optimized for best operations.

The system with capacity and material forecast disclosed herein includes a storage medium, which stores data for performing target forecast of the capacity and the material. The storage medium is further comprised of a capacity demand unit that determines the capacity demand according to a product order given by a client; a material demand unit that determines the material demand according to the material purchasing order to a supplier in accordance with the capacity demand; a capacity and material demand reporting unit that provides enterprise resource planning as the basis for making capacity and material plans; a capacity and material target forecasting module consisting of a capacity and material demand forecasting unit, which first estimates the capacity demand and unconstrained material demand and then estimates the capacity demand and constrained material demand to generate a preliminary capacity and material demand report, and output a supply chain planning result via the SCM; and a decision adjusting unit, which adjusts a purchasing plan according to the preliminary capacity and material demand report and responds to the supplier so as to adjust the material demand. The invention can provide suggestions to executive decision makers to make adjustments according to the supply chain plan so as to satisfy the company's policy or current situation.

The disclosed method with capacity and material target forecast includes the steps of: executing a batch operation using SCM software and generating a trade datum; performing the estimate of capacity demand and unconstrained material demand to generate a preliminary material demand; performing the estimate of capacity demand and constrained material demand to generate a preliminary capacity and material demand report according to the preliminary material demand; executing a branch PIR (Planned Independent Requirement) and outputting a supply chain planning result via the SCM according to the preliminary capacity and material demand report; and adjusting a purchase plan according to the preliminary capacity and material demand report, outputting an actual capacity and material demand report, and responding to a supplier so as to adjust the material demand.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of the structure of the disclosed capacity and material target forecasting system;

FIG. 2 is a flowchart showing the disclosed capacity and material target forecasting method;

FIG. 3 is a flowchart of executing PIR to perform branch material resource planning according to the disclosed method; and

FIG. 4 is a flowchart of performing estimates, adjustments and policy decisions in the disclosed method.

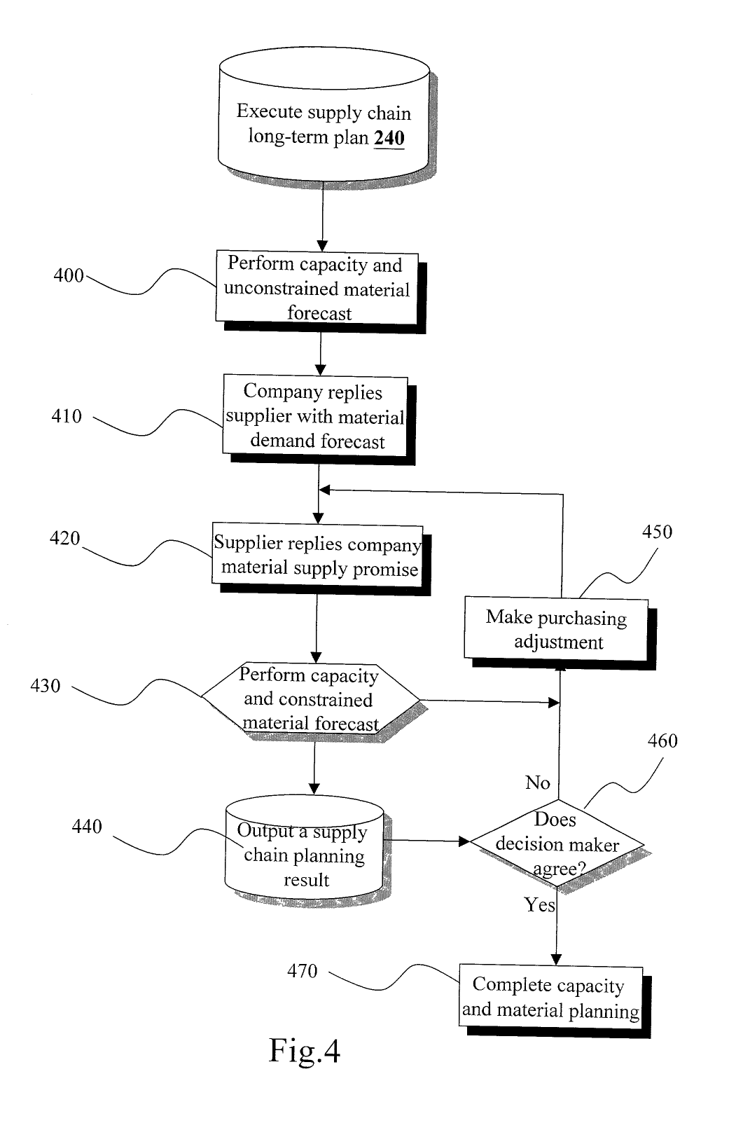

### DETAILED DESCRIPTION OF THE INVENTION

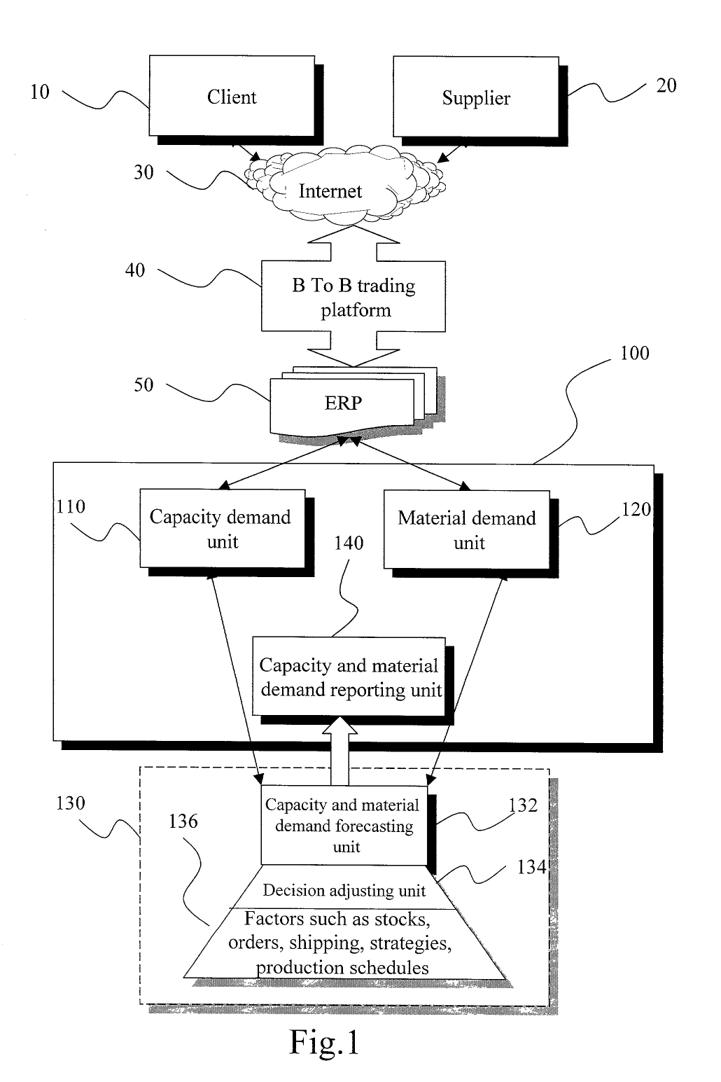

FIG. 1 is a schematic view of the structure of the disclosed capacity and material target forecasting system, illustrating the details of the system structure in the whole supply chain. The client end 10 and the supplier end 20 are connected via the Internet 30. Business trades and information transmissions are through a B-to-B trading platform 40. In general, an enterprise resource planning system 50 provides limited privilege for the client 10 and the supplier 20 to access information such as product orders, quotation of prices, and actual shipping from the client end 10 and purchasing orders, material categories, on-hand stocks from the supplier end 20. The system provides a storage medium 100 to store the data for capacity and material target forecast to satisfy the actual needs of the client 10 and the supplier 20.

The storage medium 100 includes: a capacity demand 110, a material demand unit 120, and a capacity and material demand reporting unit 140. The capacity demand unit 110 determines the capacity demand according to a product order given by the client 10. The material demand unit 120 determines the material demand according to the material purchasing order given by the supplier 20. The capacity and material demand reporting unit 140 provides an enterprise resource plan 50 as the basis of making decisions in the capacity and material plans.

The invention mainly includes a capacity and material target forecasting module 130 to satisfy the capacity demand set by the client 10 and to provide an optimal forecast for the stocks and actual shipping between the client 20 and the company. The module 130 further includes a capacity and material demand target forecasting unit 132 and a decision adjusting unit 134.

The capacity and material demand target forecasting unit 132 takes into account such factors 136 as the stocking status (including both the supplier end 20 and the company), the order status (including purchasing orders, production orders, and open sales orders), the distribution status (including product distribution and actual shipping), the company strategies (including management, price variations, etc) and the work flow. The system first estimates the capacity demand and unconstrained material demand and then estimates the capacity demand and constrained material demand. After the preliminary forecast is done, the company returns the supplier 20 a material target demand. The supplier 20 then replies the company with a material supply promise. Furthermore, a preliminary capacity and material demand forecasting report is generated by performing the capacity demand and constrained material demand forecasts. The preliminary capacity and material demand forecasting report outputs a supply chain result through the SCM (Supply Chain Management) for a decision maker to adjust the company strategies and the current needs.

The decision adjusting unit 134 performs purchase adjusts according to the preliminary capacity and material demand forecasting report. The adjusted demand forecast is sent to the supplier to adjust the material demand, achieving the goals of increasing efficiency and decreasing stocks.

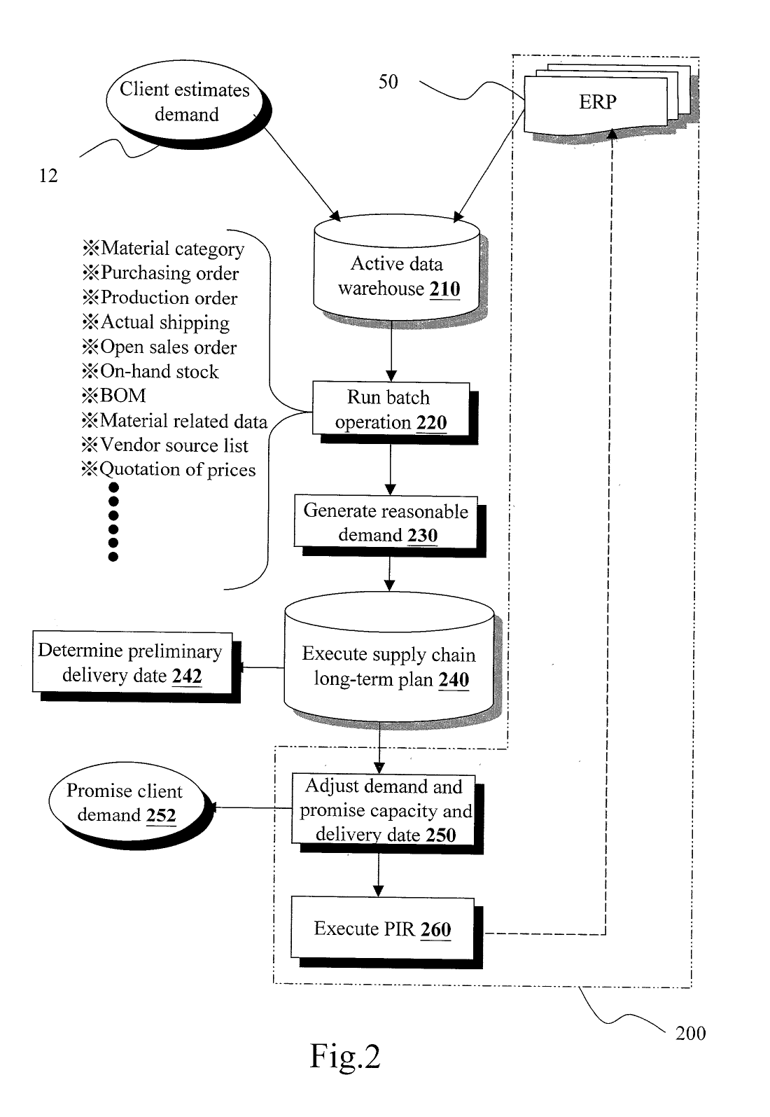

As shown in FIG. 2, the gray area illustrates the capacity and material target forecasting procedure (step 200). In general, the data warehouse is a process to analyze data and to integrate, unite, and extract different types of data operated on line. Therefore, the invention utilizes an active data warehouse (step 210) to integrate and analyze the data from the enterprise resource plan 50 and to generate effective data.

The feature of the invention is to extract the key parts in the effective data and to run a batch operation (step 220). The trading data in the key parts of the batch operation include: items, purchasing orders, production orders, actual shipping, open sales orders, on-hand stocks, BOM's (Bill Of Material), material related data, vendor source lists, and quotation of prices.

After the batch operation (step 220), the system then generates a reasonable demand (step 230) and gives the result to a supply chain management software to perform supply chain long-term planning (step 240). At the moment, the system determines an estimated delivery date (step 242). In general, the estimated delivery date computed by the supply chain management software may not be true, depending upon the attribute of the company and the types of suppliers. This is simply due to the fact that there are many uncertain factors in the attributes, stocks and shipping on both ends. To solve such a problem, the main spirit of the invention is to adjust the demand, to promise a capacity and a delivery date (step 250), and to promise the client's demand (step 252) to form a basis for business trading. A PIR (Planned Independent Requirement) is then performed (step 260) to take into account the satellite factory plans. Finally, the result is updated into the enterprise resource plan 50 for making an optimal strategy in the capacity and material planning.

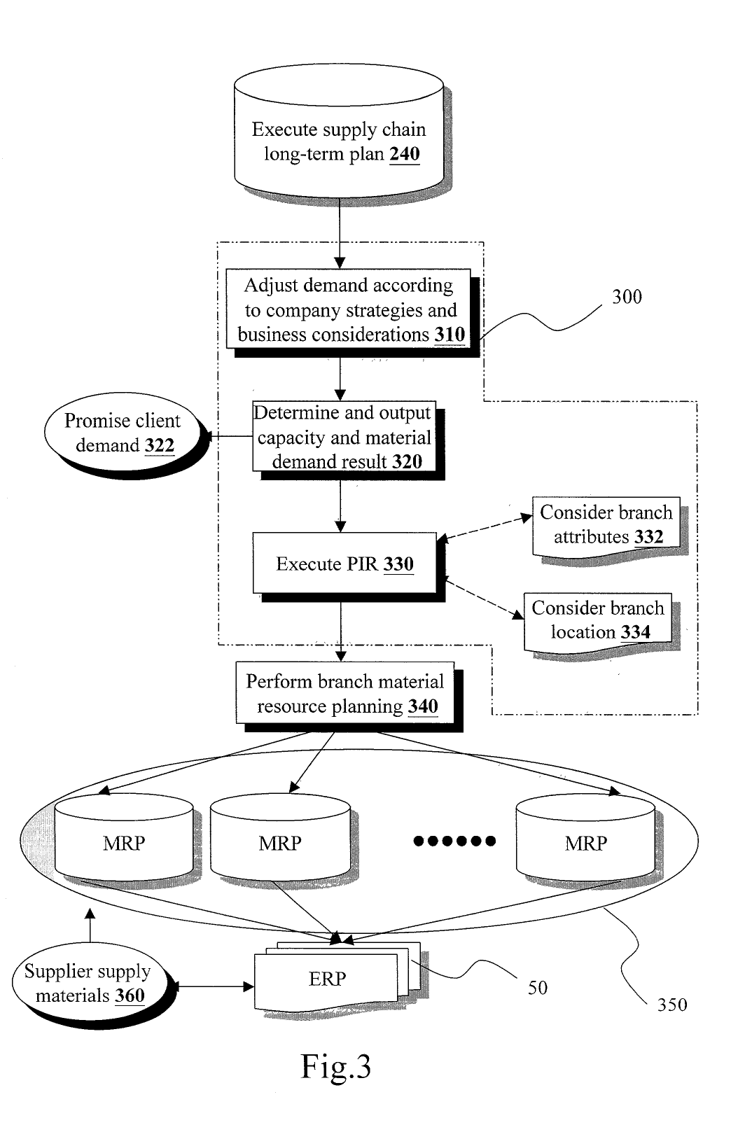

In FIG. 3, we show a flowchart of executing PIR to perform branch material resource planning according to the disclosed method. The gray area displays a detailed procedure for the PIR (step 300). After step 220 of the batch operation, the system generates a reasonable demand (step 230), which is used in a supply chain long-term plan through a supply chain management software (step 240). At the moment, the demand is adjusted according to the company strategies and business considerations (step 310). The company strategies are determined according to the operation model and actual experience between the clients, suppliers and the company. The business considerations include the price variations of materials and some temporary variables varying with the strategies. After the demand adjustment, a capacity and material demand result is determined and output (step 320). Afterwards, the company can promise the client's demand (step 322).

The output capacity and material demand result is then used for the PIR (step 330), which further takes into account the company attributes (step 332) and the location of branch offices (step 314). A branch factory material resource planning is performed in step 340 to run the material resource planning for different branches (step 350). The execution result is updated in the enterprise resource plan 50. Through a B-to-B trading platform 40, the supplier provides the materials (step 360). It provides suppliers material resource planning for an optimal material supply for different factories.

According to the disclosed method, the system generates a reasonable demand after executing the batch operation (step 220) and the result is used for the supply chain long-term plan through a supply chain management software (step 240). At the moment, a GUI (Graphics User Interface) is used to execute unconstrained material forecast (step 240). The company then returns the preliminary forecasting result to the supplier (step 410). The supplier then replies the company with a material supply promise (step 420). Afterwards, the system executes capacity and constrained material forecast (step 430) and outputs a supply chain planning result (step 440). If the result obtained by the system has some change, then the system adjusts its purchasing plan (step 450) and an optimal material supply plan is given to the supplier. If there is no change, the system presents the obtained result to the decision maker for his or her reference. The decision maker can determine whether he or she likes the plan (step 460). Due to some business concerns, such as the price variations or materials or some variables depending upon the strategies, the decision maker can make adjustment to the purchasing plan (step 450). The new plan is then sent to the supplier. Otherwise, the capacity and material planning is completed (step 470).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A capacity and material target forecasting system used in SCM (Supply Chain Management) of manufacturing industries, which comprises:
a storage medium, which stores data for making the capacity and material target forecast including at least:
a capacity demand unit, which determines he capacity demand according to a product order given from a client end;
a material demand unit, which determines the material demand according to a material purchasing order sent to a supplier in accordance with the capacity demand; and
a capacity and material demand reporting unit, which executes computation of the capacity and material plan through an enterprise resource plan for a decision-maker's reference; and
a capacity and material target forecasting module including at least:
a capacity and material demand forecasting unit, which uses a supply chain management software to run a batch operation to generate trading data, performs forecast for the capacity demand and the unconstrained material demand, then performs forecast for the capacity demand and the constrained material demand, generates a preliminary capacity and material demand forecasting report, and outputs a supply chain planning result through the supply chain management software according to the preliminary capacity and material demand forecasting report; and
a decision adjusting unit, which makes purchasing adjustment according to the preliminary capacity and material demand forecasting report and outputs an actual capacity and material demand report, which is sent to the supplier for adjusting the material demand.

2. The system of claim 1, wherein the client and the supplier are connected through the Internet and the business trades and information transmissions are performed through a B-to-B platform.

3. The system of claim 1, wherein the trading data include one combination selected from the group comprising items, purchasing orders, production orders, actual shipping, open sales orders, on-hand stocks, BOM's (Bill Of Material), material related data, vendor source lists, and quotation of prices.

4. The system of claim 1 further comprising the step of updating the supply chain plan result in the enterprise resource plan.

5. The system of claim 1, wherein the decision adjusting unit further allows a decision maker to adjust the purchasing plan.

6. The system of claim 1 further providing a GUI (Graphics User Interface) to perform forecasting operations.

7. The system of claim1, wherein the purchasing plan adjustment also performs different material resource plans according to a branch PIR (Planned Independent Requirement).

8. The system of claim 7, wherein the branch PIR takes into account the branch attributes and orientations.

9. A capacity and material target forecasting module used in the SCM for manufacturing industries to forecast an actual capacity and material demand according to a capacity demand and a material demand in order to minimizes material stocks, which module comprises:
a capacity and material demand forecasting unit, which uses a supply chain management software to run a batch operation to generate trading data, performs forecast for the capacity demand and the unconstrained material demand, then performs forecast for the capacity demand and the constrained material demand, generates a preliminary capacity and material demand forecasting report, and outputs a supply chain planning result through the supply chain management software according to the preliminary capacity and material demand forecasting report; and
a decision adjusting unit, which makes purchasing adjustment according to the preliminary capacity and material demand forecasting report and outputs an actual capacity and material demand report, which is sent to the supplier for adjusting the material demand.

10. The module of claim 9, wherein the capacity demand is determined according to a product order given from a client end.

11. The module of claim 9, wherein the material demand is determined according to a material purchasing order sent to a supplier in accordance with the capacity demand.

12. The module of claim 9, wherein the capacity demand and the material demand are connected via the Internet and the business trades and information transmissions are performed through a B-to-B platform.

13. The module of claim 9, wherein the trading data include one combination selected from the group comprising items, purchasing orders, production orders, actual shipping, open sales orders, on-hand stocks, BOM's (Bill Of Material), material related data, vendor source lists, and quotation of prices.

14. The module of claim 9 further comprising the step of updating the supply chain plan result in the enterprise resource plan.

15. The module of claim 9, wherein the decision adjusting unit further allows a decision maker to adjust the purchasing plan.

16. The module of claim 9 further providing a GUI (Graphics User Interface) to perform forecasting operations.

17. The module of claim 9, wherein the purchasing plan adjustment also performs different material resource plans according to a branch PIR (Planned Independent Requirement).

18. The module of claim 17, wherein the branch PIR takes into account the branch attributes and orientations.

19. A capacity and material target forecasting method used in the SCM of manufacturing industries, which comprises the steps of:
using a supply chain management software to run a batch operation and to generate trade data;
performing capacity demand and unconstrained material demand forecast according to the trade data and generating a preliminary material demand;
performing the capacity demand and the constrained material demand forecast according to the preliminary material demand and generating a preliminary capacity and material demand forecasting report;
executing a branch PIR according to the preliminary capacity and material demand forecasting report and outputting a supply chain planning result through the supply chain management software; and
performing purchasing adjustment according to the preliminary capacity and material demand forecasting report and outputting an actual capacity and material demand report, which is then sent to a supplier to adjust the material demand.

20. The method of claim 19, wherein the trading data include one combination selected from the group comprising items, purchasing orders, production orders, actual shipping, open sales orders, on-hand stocks, BOM's (Bill Of Material), material related data, vendor source lists, and quotation of prices.

21. The method of claim 19 further comprising the step of updating the supply chain plan result in the enterprise resource plan.

22. The method of claim 19, wherein the purchasing adjustment further allows a decision maker to adjust the purchasing plan.

23. The method of claim 19 further providing a GUI (Graphics User Interface) to perform forecasting operations.

24. The method of claim 19, wherein the purchasing adjustment also performs different material resource plans according to a branch PIR (Planned Independent Requirement).

25. The method of claim 24, wherein the branch PIR takes into account the branch attributes and orientations.
